(19) United States
(12) Patent Application Publication
(10) Pub. No.: US 2026/0000970 A1
(43) Pub. Date: Jan. 1, 2026

(54) DISPLAYING VIRTUAL BUTTONS

(71) Applicant: Tencent Technology (Shenzhen) Company Limited, Shenzhen (CN)

(72) Inventors: Jiani WANG, Shenzhen (CN); Qin LI, Shenzhen (CN)

(73) Assignee: Tencent Technology (Shenzhen) Company Limited, Shenzhen (CN)

(21) Appl. No.: 19/262,062

(22) Filed: Jul. 7, 2025

Related U.S. Application Data
(63) Continuation of application No. PCT/CN2024/086376, filed on Apr. 7, 2024.

(30) Foreign Application Priority Data
May 12, 2023 (CN) 202310541399.3

(51) Int. Cl. A63F 13/2145; A63F 13/56; A63F 13/837; G06F 3/04817; G06F 3/04842; G06F 3/0486; G06F 3/0488

(52) U.S. Cl. CPC A63F 13/2145; A63F 13/56; A63F 13/837; G06F 3/04817; G06F 3/04842; G06F 3/0486; G06F 3/0488

(57) ABSTRACT

In a method for displaying virtual buttons, a plurality of virtual buttons in a virtual scene is displayed. Each virtual button of the plurality of virtual buttons is displayed in one of an inactive form, a selectable form, and an activated form. Each virtual button is configured to trigger a virtual character to perform an interaction operation on an interaction object of the respective virtual button. In response to a determination that an initial condition associated with a virtual button of the plurality of virtual buttons being satisfied, the virtual button is switched from the inactive form to the selectable form. In response to a determination that the virtual button is triggered, the virtual button is switched from the selectable form to the activated form. In response to the virtual button being in the activated form, the virtual character is controlled to perform the interaction operation on the interaction object.

### RELATED APPLICATIONS

The present application is a continuation of International Application No. PCT/CN2024/086376, filed on Apr. 7, 2024, which claims priority to Chinese Patent Application No. 202310541399.3, filed on May 12, 2023. The entire disclosures of the prior applications are hereby incorporated by reference.

### FIELD OF THE TECHNOLOGY

This application relates to the field of computer technologies, including a method for controlling virtual buttons.

### BACKGROUND OF THE DISCLOSURE

Virtual buttons (also referred to as virtual keys) are physical keys simulated on a mobile device such as a mobile phone by using software.

The virtual buttons are an alternative solution to the physical keys, and are used in a manner similar to that of the physical keys, but the virtual buttons do not have actual physical structures. The virtual buttons are implemented on a screen, and various operations are completed by touching the screen. When a user taps on a virtual button, a system may trigger a corresponding operation or function, and display a corresponding response on the screen. For example, in some games, the virtual button may be configured for controlling a movement and attack action of a game character.

### SUMMARY

Aspects of this disclosure include a method for controlling virtual buttons, an apparatus, and a non-transitory computer-readable storage medium, to at least resolve the technical problem that displaying of virtual buttons is not intuitive enough.

Examples of technical solutions of this disclosure may be implemented as follows:

An aspect of this disclosure provides a method for displaying virtual buttons. A plurality of virtual buttons in a virtual scene is displayed. Each virtual button of the plurality of virtual buttons is displayed in one of an inactive form, a selectable form, and an activated form. Each virtual button is configured to trigger a virtual character to perform an interaction operation on an interaction object of the respective virtual button. The interaction objects of the plurality of virtual buttons are different. In response to a determination that an initial condition associated with a virtual button of the plurality of virtual buttons being satisfied, the virtual button is switched from the inactive form to the selectable form. In response to a determination that the virtual button is triggered, the virtual button is switched from the selectable form to the activated form. In response to the virtual button being in the activated form, the virtual character is controlled to perform the interaction operation on the interaction object corresponding to the virtual button.

An aspect of this disclosure provides an apparatus for displaying virtual buttons. The apparatus includes processing circuitry configured to display a plurality of virtual buttons in a virtual scene. Each virtual button of the plurality of virtual buttons is displayed in one of an inactive form, a selectable form, and an activated form. Each virtual button is configured to trigger a virtual character to perform an interaction operation on an interaction object of the respective virtual button. The interaction objects of the plurality of virtual buttons are different. In response to a determination that an initial condition associated with a virtual button of the plurality of virtual buttons being satisfied, the processing circuitry is configured to switch the virtual button from the inactive form to the selectable form. In response to a determination that the virtual button is triggered, the processing circuitry is configured to switch the virtual button from the selectable form to the activated form. In response to the virtual button being in the activated form, the processing circuitry is configured to control the virtual character to perform the interaction operation on the interaction object corresponding to the virtual button.

An aspect of this disclosure provides a method for controlling virtual buttons, including: displaying at least two virtual buttons in a virtual scene, each of the at least two virtual buttons being displayed in an inactive form or a ready-for-activation form, each of the at least two virtual buttons being configured for triggering a virtual character to perform an interaction operation on an interaction object corresponding to the virtual button, and interaction objects corresponding to virtual buttons among the at least two virtual buttons being different; for a virtual button in a form of waiting to be activated, switching the virtual button to the ready-for-activation form in a case that an initial trigger condition corresponding to the interaction operation performed by the virtual character on the interaction object corresponding to the virtual button is met; and for the virtual button in the ready-for-activation form, switching the virtual button to an activated form in a case that a target trigger condition corresponding to the interaction operation performed by the virtual character on the interaction object corresponding to the virtual button is met, and controlling the virtual character to perform the interaction operation on the interaction object corresponding to the virtual button.

An aspect of this disclosure further provides an apparatus for controlling virtual buttons, including: a first display unit, configured to display at least two virtual buttons in a virtual scene, each of the at least two virtual buttons being displayed in an inactive form or a ready-for-activation form, each of the at least two virtual buttons being configured for triggering a virtual character to perform an interaction operation on an interaction object corresponding to the virtual button, and interaction objects corresponding to virtual buttons among the at least two virtual buttons being different; a second display unit, configured to: for a virtual button in a form of waiting to be activated, switch the virtual button to the ready-for-activation form in a case that an initial trigger condition corresponding to the interaction operation performed by the virtual character on the interaction object corresponding to the virtual button is met; and a third display unit, configured to: for the virtual button in the ready-for-activation form, switch the virtual button to an activated form in a case that a target trigger condition corresponding to the interaction operation performed by the virtual character on the interaction object corresponding to the virtual button is met, and control the virtual character to perform the interaction operation on the interaction object corresponding to the virtual button.

An aspect of this disclosure further provides a computer program product or a computer program, the computer program product or the computer program including computer instructions, the computer instructions being stored in a computer-readable storage medium. A processor of a computer device reads the computer instructions from the computer-readable storage medium, and executes the computer instructions, to cause the computer device to perform the foregoing method for controlling virtual buttons.

An aspect of this disclosure provides an electronic device, including a memory, a processor, and a computer program stored on the memory and executable on the processor, the processor performing the foregoing method for controlling virtual buttons by using the computer program.

An aspect of this disclosure further provides a non-transitory computer-readable storage medium, having computer-executable instructions stored therein, the computer-executable instructions, when executed by a processor, cause the processor to implement the method for displaying virtual buttons provided in the aspects of this disclosure.

### BRIEF DESCRIPTION OF THE DRAWINGS

FIG. 1 is a schematic diagram of an application environment of a method for controlling virtual buttons according to an aspect of this disclosure.

FIG. 2 is a schematic flowchart of a method for controlling virtual buttons according to an aspect of this disclosure.

FIG. 3 is a schematic diagram of a method for controlling virtual buttons according to an aspect of this disclosure.

FIG. 4 is a schematic diagram of another method for controlling virtual buttons according to an aspect of this disclosure.

FIG. 5 is a schematic diagram of another method for controlling virtual buttons according to an aspect of this disclosure.

FIG. 6 is a schematic diagram of another method for controlling virtual buttons according to an aspect of this disclosure.

FIG. 7 is a schematic diagram of another method for controlling virtual buttons according to an aspect of this disclosure.

FIG. 8 is a schematic diagram of another method for controlling virtual buttons according to an aspect of this disclosure.

FIG. 9 is a schematic diagram of another method for controlling virtual buttons according to an aspect of this disclosure.

FIG. 10 is a schematic diagram of another method for controlling virtual buttons according to an aspect of this disclosure.

FIG. 11 is a schematic diagram of another method for controlling virtual buttons according to an aspect of this disclosure.

FIG. 12 is a schematic diagram of another method for controlling virtual buttons according to an aspect of this disclosure.

FIG. 13 is a schematic diagram of another method for controlling virtual buttons according to an aspect of this disclosure.

FIG. 14 is a schematic diagram of another method for controlling virtual buttons according to an aspect of this disclosure.

FIG. 15 is a schematic diagram of another method for controlling virtual buttons according to an aspect of this disclosure.

FIG. 16 is a schematic diagram of another method for controlling virtual buttons according to an aspect of this disclosure.

FIG. 17 is a schematic diagram of an apparatus for controlling virtual buttons according to an aspect of this disclosure.

FIG. 18 is a schematic structural diagram of an electronic device according to an aspect of this disclosure.

### DETAILED DESCRIPTION

To make a person skilled in the art better understand the solutions of this disclosure, the following describes the technical solutions in the aspects of this disclosure with reference to the accompanying drawings in the aspects of this disclosure. The described aspects are only some of the aspects of this disclosure rather than all of the aspects. All other aspects obtained by a person of ordinary skill in the art based on the aspects of this disclosure shall fall within the scope of this disclosure. Further, the descriptions of the terms are provided as examples only and are not intended to limit the scope of the disclosure.

Terms “first”, “second”, and the like in the specification, the claims, and the above drawings of the aspects of this disclosure are intended to distinguish between similar objects, rather than describe a specific sequence or order. Such used data is interchangeable where appropriate so that the aspects of this disclosure described here can be implemented in an order other than those illustrated or described here. Moreover, the terms “include”, “contain” and any other variants mean to cover the non-exclusive inclusion, for example, a process, method, system, product, or device that includes a list of steps or units is not necessarily limited to those expressly listed steps or units, but may include other steps or units not expressly listed or inherent to such a process, method, product, or device.

In some methods, in a scenario in which an operation is triggered by using a virtual button, especially, a triggered operation type is relatively complex, for example, an operation type that interaction operations need to be performed with a plurality of interaction objects, it is quite difficult for a user to determine which virtual button to be used and on which interaction object an interaction operation is to be performed, and it is more difficult to determine whether a current virtual button can perform the interaction operation on the interaction object, further resulting in the difficulty in triggering the operation by using the virtual button and the reduction of the user experience. The reason for this is that displaying of the virtual buttons by using these methods is not intuitive enough.

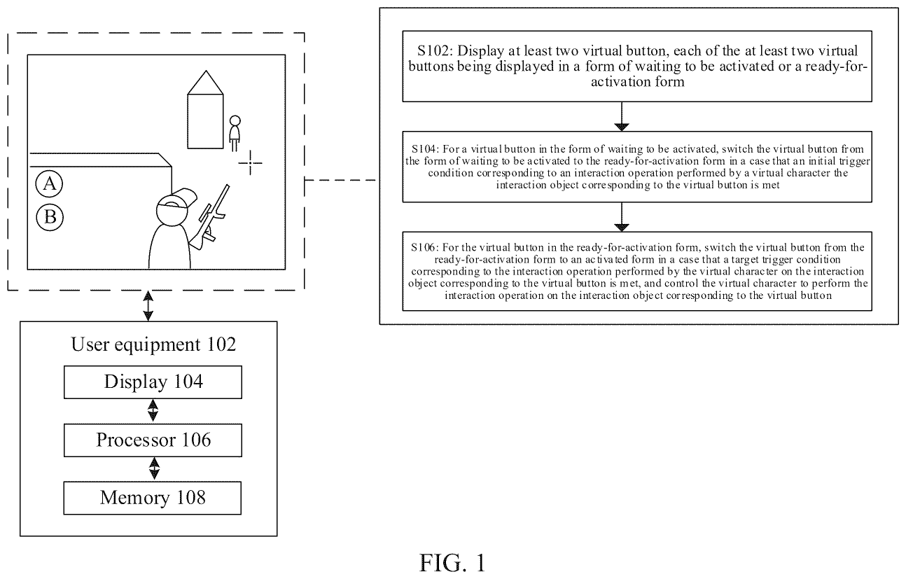

A method for controlling virtual buttons provided in aspects of this disclosure may be applied to, but is not limited to, an environment shown in FIG. 1. The environment may include, but is not limited to, user equipment 102. The user equipment 102 may include, but is not limited to, a display 104, a processor 106, and a memory 108.

Specific processes are as following operations.

Operations S102 to S106: User equipment 102 displays, by using a processor 106, at least two virtual buttons on a display 104, each of the at least two virtual buttons being displayed in a form of waiting to be activated or a ready-for-activation form; for a virtual button in the form of waiting to be activated, switches the virtual button from the form of waiting to be activated to the ready-for-activation form in a case that an initial trigger condition corresponding to an interaction operation performed by a virtual character on the interaction object corresponding to the virtual button is met; and for the virtual button in the ready-for-activation form, switches the virtual button from the ready-for-activation form to an activated form in a case that a target trigger condition corresponding to the interaction operation performed by the virtual character on the interaction object corresponding to the virtual button is met, and controls the virtual character to perform the interaction operation on the interaction object corresponding to the virtual button.

In addition to the example shown in FIG. 1, the user equipment 102 includes, but is not limited to, a handheld device (such as a mobile phone), a laptop, a tablet, a desktop computer, an on-board device, a smart TV set, and the like. The specific implementations of the user equipment 102 are not limited in this disclosure.

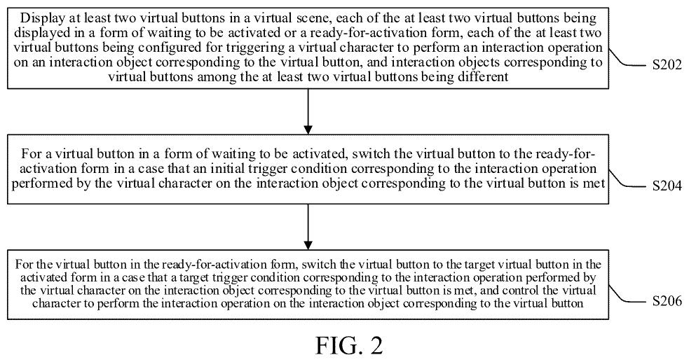

In some aspects, as shown in FIG. 2, the method for controlling virtual buttons may be performed by an electronic device, for example, the user equipment shown in FIG. 1. Specific operations include:

S202: Display at least two virtual buttons in a virtual scene, each of the at least two virtual buttons being displayed in a form of waiting to be activated or a ready-for-activation form, each of the at least two virtual buttons being configured for triggering a virtual character to perform an interaction operation on an interaction object corresponding to the virtual button, and interaction objects corresponding to virtual buttons among the at least two virtual buttons being different. For example, a plurality of virtual buttons in a virtual scene is displayed. Each virtual button of the plurality of virtual buttons is displayed in one of an inactive form, a selectable form, and an activated form. Each virtual button is configured to trigger a virtual character to perform an interaction operation on an interaction object of the respective virtual button. The interaction objects of the plurality of virtual buttons are different.

S204: For a virtual button in the form of waiting to be activated, switch the virtual button to the ready-for-activation form in a case that an initial trigger condition corresponding to the interaction operation performed by the virtual character on the interaction object corresponding to the virtual button is met. For example, in response to a determination that an initial condition associated with a virtual button of the plurality of virtual buttons being satisfied, the virtual button is switched from the inactive form to the selectable form.

S206: For the virtual button in the ready-for-activation form, switch the virtual button to a target virtual button in an activated form in a case that a target trigger condition corresponding to the interaction operation performed by the virtual character on the interaction object corresponding to the virtual button is met, and control the virtual character to perform the interaction operation on the interaction object corresponding to the virtual button. For example, in response to a determination that the virtual button is triggered, the virtual button is switched from the selectable form to the activated form. In response to the virtual button being in the activated form, the virtual character is controlled to perform the interaction operation on the interaction object corresponding to the virtual button.

In some aspects, the foregoing method for controlling virtual buttons may be, but is not limited to, applied to a virtual game. For example, in a running process of a round of a virtual game, a user controls, by using a virtual button, a virtual character to perform an interaction operations on interaction objects, and distinguishes, by using different forms of the virtual button, which interaction object that an interaction operation can be currently performed on, whether the interaction operation is successfully performed, and the like. For example, a virtual button in a form of waiting to be activated indicates that an interaction operation may not be currently performed on an interaction object corresponding to the virtual button, a virtual button in a ready-for-activation form indicates that an interaction operation may be currently performed on an interaction object corresponding to the virtual button, and a virtual button in an activated form indicates that an interaction operation is currently being performed on an interaction object corresponding to the virtual button.

In some aspects, the virtual character may be, but is not limited to, a virtual character manipulated by using a virtual button, for example, a first-person virtual character or a third-person virtual character. In some aspects, the interaction object may be, but is not limited to, a virtual object that allows triggering execution of an interaction operation with a virtual character, for example, a virtual character, a virtual prop, or a virtual building.

In addition, in some aspects, the interaction object may alternatively be, but is not limited to, a virtual object obtained by a virtual character by performing an associated operation. For example, the virtual character releases (the associated operation) a target prop (the interaction object), and further performs a detonation operation (the interaction operation) on the target prop, to detonate the target prop, thereby further causing ranged damage. However, in a case that the interaction object is one of the cases listed in the foregoing aspects, a user not only needs to perform the release operation (the associated operation) of releasing the target prop, but also needs to perform the interaction operation of detonating the target prop, resulting in the increase of the probability of misoperations of the user. However, in some scenarios having a high requirement on a time limit, for example, in a scenario in which an interaction operation can be better performed only by aiming at the target prop within a short preset time after a virtual character releases or throws a target prop, a user not only needs to perform the release operation of releasing the target prop, but also needs to perform the interaction operation of aiming the target prop to detonate same within a short time, further resulting in the increase of the probability of misoperations of the user and reduction of the execution accuracy of the interaction operation.

In this aspect, a trigger button of the interaction operation is set to a particular virtual button, so that after performing the release operation, the user may quickly perform the corresponding interaction operation by using the virtual button. Not only the execution efficiency of the interaction operation is increased, but also the probability of misoperations of the user is reduced after the release operation and the interaction operation are decoupled, and further the execution accuracy of the interaction operation is increased.

In some aspects, the virtual button is configured for triggering an interaction operation performed by a virtual character on an interaction object corresponding to the virtual button. Interaction objects corresponding to virtual buttons among at least two virtual buttons are different and are different from general buttons. In this aspect, the virtual buttons are in one-to-one mapping with the interaction objects. That is, one virtual button may be, but is not limited to, corresponding to triggering of an interaction operation of one interaction object or one type of interaction objects. Moreover, the general buttons may be, but are not limited to, corresponding to triggering of an interaction operation of a plurality of interaction objects or a plurality of types of interaction objects, or in addition to an interaction operation, the general buttons may be further configured for triggering other operations.

Further, for example, a button “jump” is configured for triggering a virtual character to perform a jumping operation. When the virtual character is located near any interaction object “wall” that can be crossed over, the foregoing button “jump” may further be configured for triggering a wall-crossing operation (the interaction operation) performed by the virtual character on the foregoing interaction object “wall”, and further the foregoing button “jump” may be determined as a general button. The virtual button in this aspect may be, but is not limited to, only configured for triggering a wall-crossing operation (the interaction operation) performed by the virtual character on the interaction object “wall” and not additionally for triggering another operation.

In addition, when the virtual character is not located near any interaction object “wall” that can be crossed over, the virtual button is displayed in a form of waiting to be activated, and when the virtual character is located near any interaction object “wall” that can be crossed over, the virtual button is displayed in a ready-for-activation form, so that the user can more intuitively clarify an execution state of the wall-crossing operation by observing a display form of the virtual button.

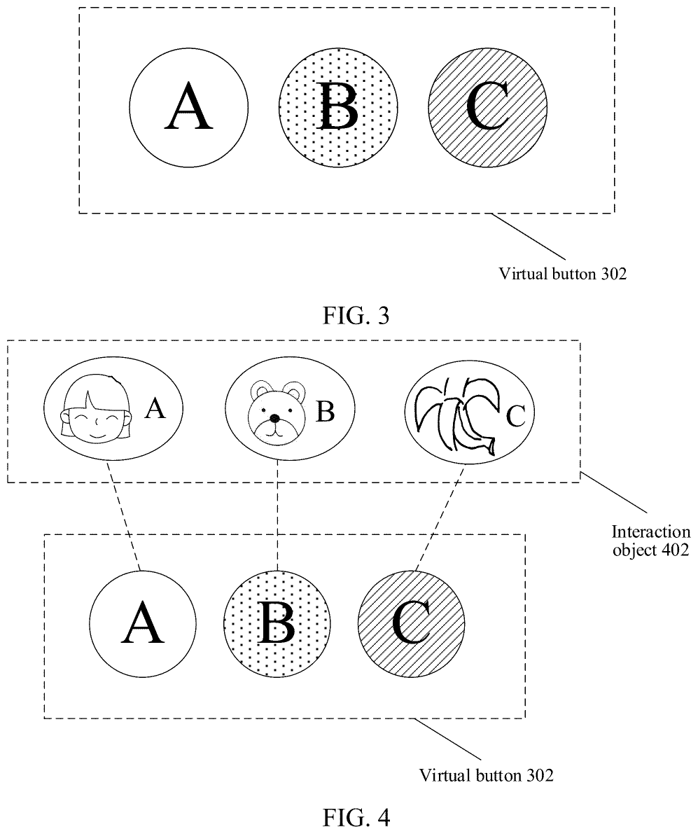

In some aspects, virtual buttons among the at least two virtual buttons may simultaneously present different forms, for example, a virtual button A among the at least two virtual buttons presents a form of waiting to be activated, a virtual button B among the at least two virtual buttons presents a ready-for-activation form, and a virtual button C among the at least two virtual buttons presents an activated form. In addition, to highlight the differences between different states, the form of waiting to be activated, the ready-for-activation form, and the activated form may be set to, but are not limited to, forms having large difference in displaying. As shown in FIG. 3, a virtual button A among at least two virtual buttons 302 presents a form of waiting to be activated (pure white filled), a virtual button B among the at least two virtual buttons 302 presents a ready-for-activation form (light shaded), and a virtual button C among the at least two virtual buttons 302 presents an activated form (dark shaded).

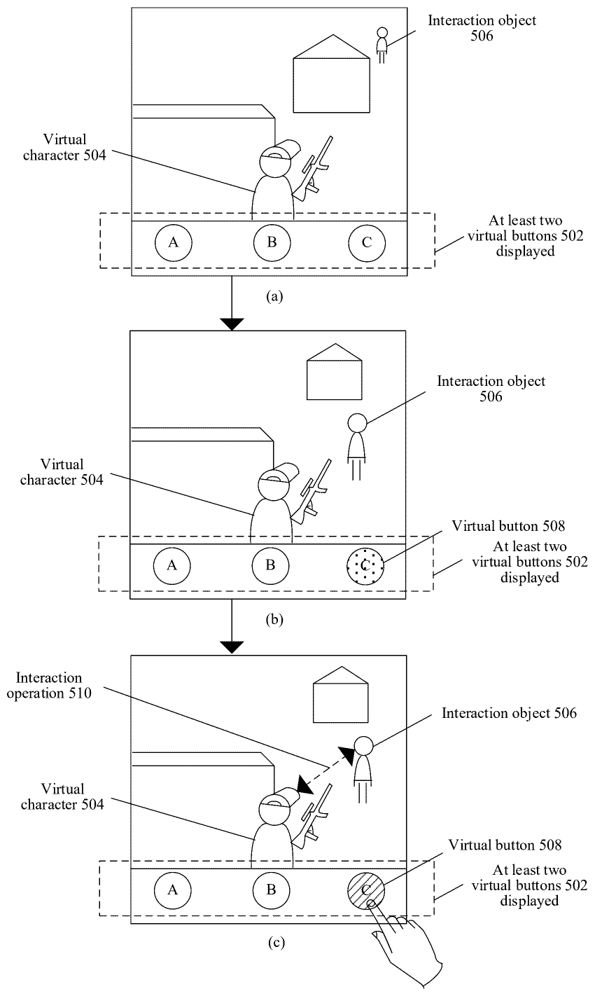

In some aspects, that interaction objects corresponding to virtual buttons among the at least two virtual buttons are different may be, but is not limited to, that one virtual button corresponds to one interaction object or one type of interaction objects. As shown in FIG. 4, the virtual button A among the at least two virtual buttons 302 corresponds to an interaction object A among interaction objects 402, the virtual button B among the at least two virtual buttons 302 corresponds to an interaction object B among the interaction objects 402, and the virtual button C among the at least two virtual buttons 302 corresponds to an interaction object C among the interaction objects 402.

In some aspects, the determining whether the initial trigger condition corresponding to the interaction operation performed by the virtual character on the interaction object corresponding to the virtual button is met may include, but is not limited to, being based on parameter information associated with the virtual character. The parameter information includes related information (for example, holding an interaction prop) of the virtual character, and may further include relative information (for example, a relative distance) between the virtual character and the interaction object corresponding to the virtual button.

In some aspects, the determining whether the target trigger condition corresponding to the interaction operation performed by the virtual character on the interaction object corresponding to the virtual button is met may include, but is not limited to, being based on an associated operation performed on the virtual button in the ready-for-activation form. The associated operation may be a selected operation, a press-and-hold operation, a slide operation, a voice control operation, a release operation, or the like.

Different virtual buttons are provided to trigger interaction operations performed by a virtual character on different interaction objects, so that the accuracy of triggering interaction operations by using virtual buttons is improved. Representation manners of the form of waiting to be activated, the ready-for-activation form, and the activated form are further used to help the user determine which trigger stages the interaction operations are currently in, to intuitively present the virtual buttons in different trigger states, so that the technical effect of improving the intuitiveness of displaying the virtual buttons is achieved.

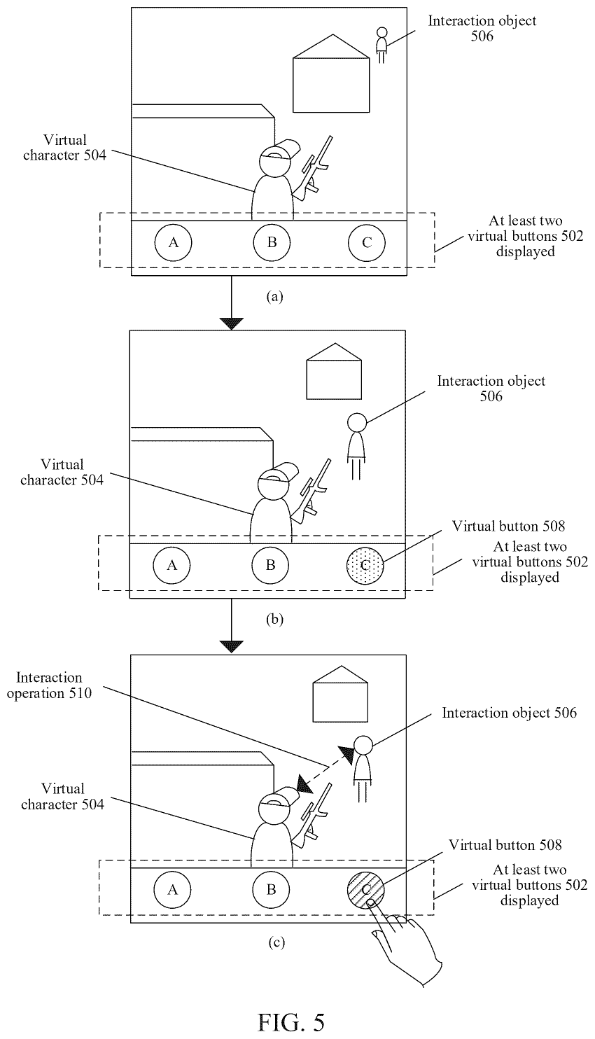

Further, for example, as shown in FIG. 5(a), at least two virtual buttons 502 in a form of waiting to be activated (pure white filled) are displayed. The at least two virtual buttons 502 are configured for triggering interaction operations (for example, an interaction operation 510 performed on an interaction object 506) performed by a virtual character 504 on interaction objects (for example, the interaction object 506). Virtual buttons among the at least two virtual buttons 502 correspond to different interaction objects. For example, a virtual button A, a virtual button B, and a virtual button C correspond to different interaction objects. Further, as shown in FIG. 5(b), for a virtual button 508 (the virtual button C) in the form of waiting to be activated, in a case that an initial trigger condition corresponding to the interaction operation 510 performed by the virtual character 504 on the interaction object 506 is met, the virtual button 508 is switched to the ready-for-activation form (light shaded). The interaction object 506 is an interaction object corresponding to the virtual button 508. Further, as shown in FIG. 5(c), for the virtual button 508 in the ready-for-activation form, in a case that a target trigger condition corresponding to the interaction operation 510 performed by the virtual character 504 on the interaction object 506 is met, the virtual button 508 is switched to the activated form (dark shaded), and the virtual character 504 is controlled to perform the interaction operation 510 on the interaction object 506.

According to the aspects provided in this disclosure, at least two virtual buttons are displayed in a virtual scene, each of the at least two virtual buttons being displayed in a form of waiting to be activated or a ready-for-activation form, each of the at least two virtual buttons being configured for triggering a virtual character to perform an interaction operation on an interaction object corresponding to the virtual button, and interaction objects corresponding to virtual buttons among the at least two virtual buttons being different; for a virtual button in the form of waiting to be activated, the virtual button is switched to the ready-for-activation form in a case that an initial trigger condition corresponding to the interaction operation performed by the virtual character on the interaction object corresponding to the virtual button is met; and for the virtual button in the ready-for-activation form, in a case that a target trigger condition corresponding to the interaction operation performed by the virtual character on the interaction object corresponding to the virtual button is met, the virtual button is switched to the activated form, and the virtual character is controlled to perform the interaction operation on the interaction object corresponding to the virtual button. Different virtual buttons are provided to trigger interaction operations performed by a virtual character on different interaction objects, so that the accuracy of triggering interaction operations by using virtual buttons is improved. Representation manners of the form of waiting to be activated, the ready-for-activation form, and the activated form are further used to help the user determine which trigger stages the interaction operations are currently in, to intuitively present virtual buttons in different trigger states, so that the technical effect of improving the intuitiveness of displaying the virtual buttons is achieved, and the technical problem that displaying of the virtual buttons is not intuitive enough is solved.

In some aspects, the displaying at least two virtual buttons includes:
displaying a first virtual button having a first mark, and a second virtual button having a second mark, the first mark being displayed on the first virtual button, the second mark being displayed on the second virtual button, the first mark being configured for representing a first interaction object corresponding to the first virtual button, and the second mark being configured for representing a second interaction object corresponding to the second virtual button.

In some aspects, a mark is configured for representing an interaction object corresponding to a virtual button. For example, a mark A is configured for representing an interaction object A corresponding to a virtual button, a mark B is configured for representing an interaction object B corresponding to a virtual button, a mark C is configured for representing an interaction object C corresponding to a virtual button. As shown in FIG. 5, the interaction object 506 corresponding to the virtual button 508 having the mark C may be, but is not limited to, the interaction object C.

A mapping relationship between the virtual button and the interaction object may be indicated more intuitively by means of marking, thereby further improving the intuitiveness of displaying the virtual button.

According to the aspects provided by this disclosure, a first virtual button and a second virtual button are displayed, a first mark being displayed on the first virtual button, a second mark being displayed on the second virtual button, the first mark being configured for representing a first interaction object corresponding to the first virtual button, and the second mark being configured for representing a second interaction object corresponding to the second virtual button, so that the purpose of indicating a mapping relationship between the virtual button and the interaction object more intuitively by means of marking can be achieved, thereby further improving the intuitiveness of displaying the virtual button.

In some aspects, the displaying a first virtual button having a first mark, and a second virtual button having a second mark includes:
displaying the first virtual button having the first mark before the second virtual button having the second mark in a case that a display rank corresponding to the first mark is before a display rank corresponding to the second mark, the display ranks of the first mark and the second mark being determined according to a sorting rule corresponding to mark types to which the first mark and the second mark pertain.

In some aspects, marks capable of indicating the display ranks, such as a mark 1, a mark 2, and a mark 3, are marks of a numeral type, and the display ranks corresponding to the mark 1, the mark 2, and the mark 3 may be determined according to sorting rule of an ascending order of numerals. Still for example, a mark A, a mark B, and a mark C are marks of a letter type, and the display ranks corresponding to the mark A, the mark B, and the mark C may be determined according to a sorting rule of an alphabetical order of 26 alphabets. Still for example, a mouse mark, an ox mark, and a tiger mark are marks of a Chinese Zodiac type, and the display ranks corresponding to the mouse mark, the ox mark, and the tiger mark may be determined according to a sorting rule of the twelve animals in the Chinese Zodiac.

Further, for example, as shown in FIG. 6, a plurality of virtual buttons 602 (for example, a virtual button 2, a virtual button 1, and a virtual button 3, where the numerals are configured for representing the marks in the virtual buttons) are displayed and sorted according to the numerals. For example, the virtual button 602 having the mark 1 is displayed before the virtual button 602 having the mark 2, and the virtual button 602 having the mark 2 is displayed before the virtual button 602 having the mark 3.

By using a plurality of virtual buttons corresponding to different interaction objects, the accuracy of triggering, by using the virtual buttons, interaction operations performed on interaction objects can be improved. However, an excessively large number of virtual buttons may increase the execution difficulty for a user, increase the probability of misoperations, and reduce the accuracy of triggering, by using virtual buttons, interaction operations performed on interaction objects. In this aspect, the virtual buttons are displayed and sorted by using marks in an order, and a user may determine, based on an arrangement order of different virtual buttons, which interaction operation is triggered by each virtual button, so that the probability of misoperations is reduced, and the accuracy of triggering, by using virtual button, interaction operations performed on interaction objects is improved.

According to this aspect provided in this disclosure, when the display rank corresponding to the first mark is before the display rank corresponding to the second mark, the first virtual button having the first mark is displayed before the second virtual button having the second mark, so that the purpose of reducing the probability of misoperations can be reduced, and the technical effect of improving the accuracy of triggering, by using virtual buttons, interaction operations performed on interaction objects is achieved.

In some aspects, the displaying a first virtual button having a first mark, and a second virtual button having a second mark includes:
displaying the first virtual button in a first form and having the first mark, and the second virtual button in the first form and having a second mark in a case that the first interaction object and the second interaction object pertain to a same object type, the first form being configured for representing an object type to which the first interaction object and the second interaction object pertain; or
displaying a first virtual button in a second form and having a first mark, and a second virtual button in a third form and having a second mark in a case that the first interaction object and the second interaction object are in different object types, the second form being configured for representing an object type to which the first interaction object pertains, and the third form being configured for representing an object type to which the second interaction object pertains.

In some aspects, the forms of the virtual buttons are configured for representing the object types to which the interaction objects corresponding to the virtual buttons pertain. For example, a virtual button in a form A corresponds to an interaction object of an object type A, a virtual button in a form B corresponds to an interaction object of an object type B, and a virtual button in a form C corresponds to an interaction object of an object type C. The forms may include, but are not limited to, a color, a shape, a special effect, a pattern, and the like.

A relationship between a form and a mark may be, but is not limited to, that in a case that the interaction objects are of a single object type, the interaction objects may be, but are not limited to, indicated by using marks; however, in a case that interaction objects are of a plurality of object types, the object types to which the interaction objects pertain cannot be intuitively indicated if marks are used only, and in a case that there are a relatively large number of interaction objects, different marks cause memorization difficulty for a user, which is not beneficial to intuitive expression of the virtual buttons; further, in a case that the interaction objects are of a plurality of object types, the object types to which the interaction objects pertain are intuitively indicated by combining forms and marks. In addition, different marks are displayed under a same object type, and a same mark may be displayed under different object types. The number of redundant marks can be reduced, to further reduce the memorization difficulty for the user, and further the intuitiveness of displaying the virtual buttons is increased.

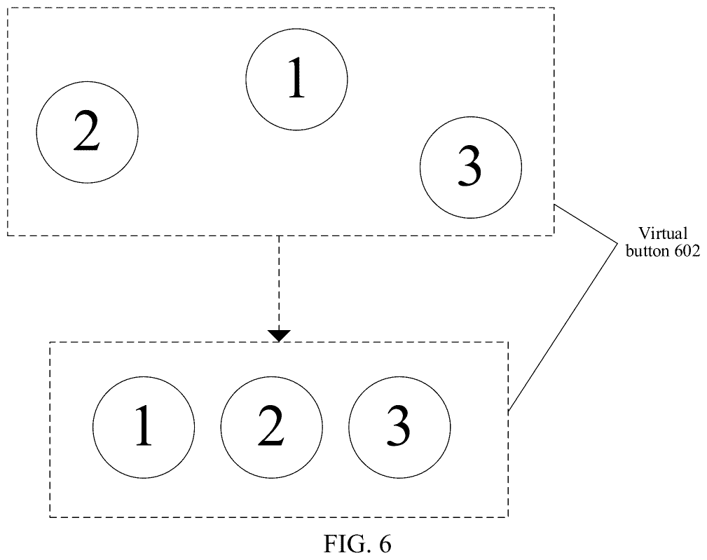

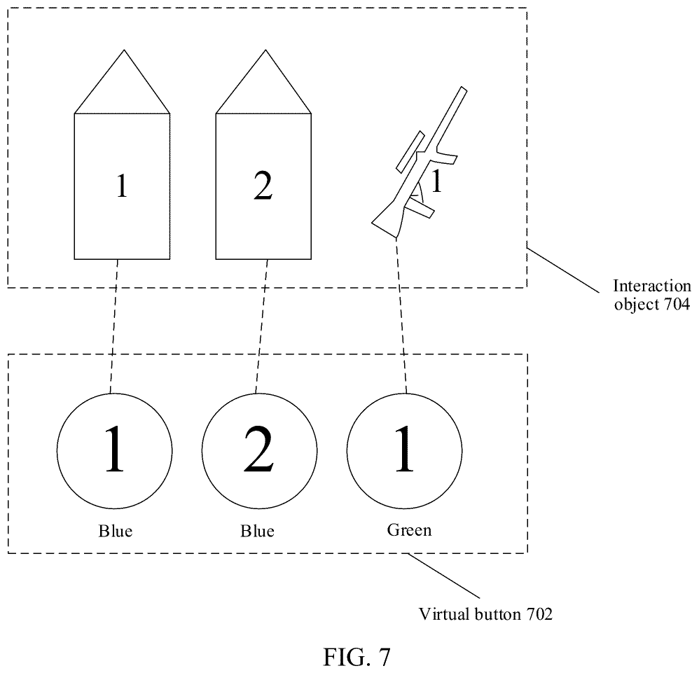

Further, for example, as shown in FIG. 7, virtual buttons among a plurality of virtual buttons 702 correspond to different interaction objects among a plurality of interaction objects 704. For example, a virtual button 702 in blue (the color is indicated by literal text in the figure) and having a mark 1 corresponds to an interaction object 1 of a building type, a virtual button 702 in blue (the color is indicated by literal text in the figure) and having a mark 2 corresponds to an interaction object 2 of a building type, and a virtual button 702 in green (the color is indicated by literal text in the figure) and having a mark 1 corresponds to an interaction object 1 of a prop type.

According to the aspects provided in this disclosure, a first virtual button in a first form and having a first mark, and a second virtual button in the first form and having a second mark are displayed in a case that the first interaction object and the second interaction object pertain to a same object type, the first form being configured for representing an object type to which the first interaction object and the second interaction object pertain; or a first virtual button in a second form and having a first mark, and a second virtual button in a third form and having a second mark are displayed in a case that the first interaction object and the second interaction object are in different object types, the second form being configured for representing an object type to which the first interaction object pertains, and the third form being configured for representing an object type to which the second interaction object pertains, so that the purposes of intuitively indicating the object types to which the interaction objects pertain, and reducing the number of redundant marks to further reduce the memorization difficulty of the user in a case that there are a relatively large number of interaction objects are achieved, and further the technical effect of increasing the intuitiveness of displaying the virtual buttons is achieved.

In some aspects, the first virtual button in the first form and having the first mark and the second virtual button in the first form and having the second mark may be displayed in a same area in a case that the first interaction object and the second interaction object pertain to a same object type.

In some aspects, the first virtual button in the second form and having the first mark and the second virtual button in the third form and having the second mark are displayed in different areas in a case that the first interaction object and the second interaction object are in different object types.

By using a plurality of virtual buttons corresponding to different interaction objects, the accuracy of triggering, by using the virtual buttons, interaction operations performed on interaction objects can be improved. However, an excessively large number of virtual buttons may increase the execution difficulty for a user, increase the probability of misoperations, and reduce the accuracy of triggering, by using virtual buttons, interaction operations performed on interaction objects. In this aspect, by performing centralized sorting on the virtual buttons according to a same mark and/or form, a user can easier memorize trigger targets corresponding to the virtual buttons, that is, the user can easier clarify which interaction operation is to be triggered by a virtual button, so that the probability of misoperations is reduced, and the accuracy of triggering, by using virtual buttons, interaction operations performed on interaction objects is improved.

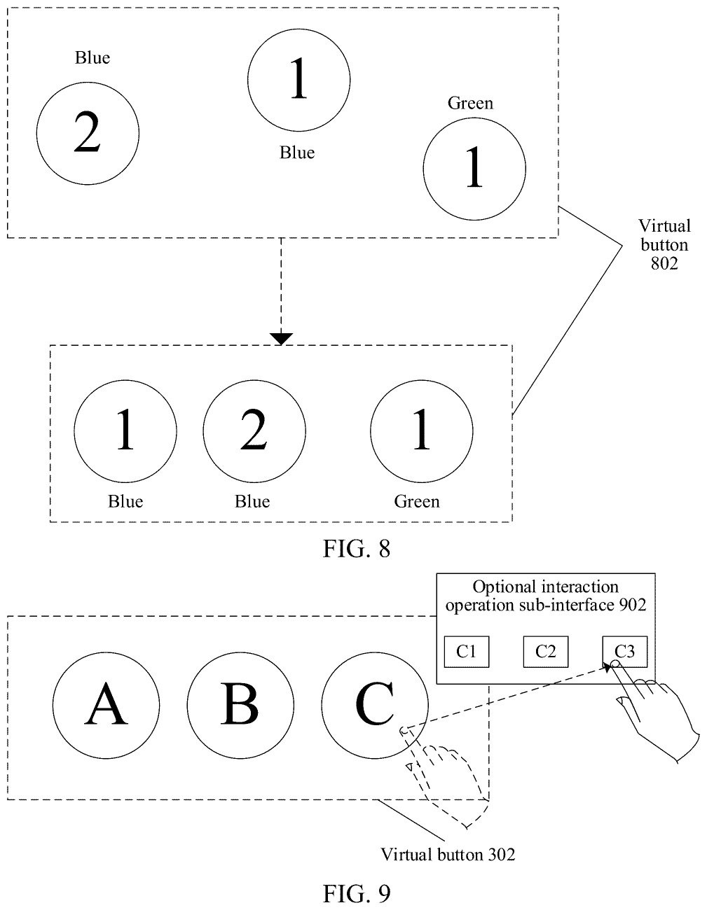

Further, for example, as shown in FIG. 8, for a plurality of virtual buttons 802 (for example, a virtual button 2 in blue, a virtual button 1 in blue, and a virtual button 1 in green, where the numerals are configured for representing marks in the virtual buttons), the virtual buttons are collectively sorted according to forms. For example, the virtual button 2 in blue and the virtual button 1 in blue are centralized in a same area, and the virtual button 1 in green is arranged in another area.

In this aspect provided in this disclosure, the first virtual button in the first form and having the first mark and the second virtual button in the first form and having the second mark are displayed in the same area. The first virtual button in the second form and having the first mark and the second virtual button in the third form and having the second mark are displayed in different areas, so that the purpose of reducing the probability of misoperations can be reduced, and the technical effect of improving the accuracy of triggering, by using virtual buttons, interaction operations performed on interaction objects is achieved.

In some aspects, before the switching the virtual button to the activated form, and controlling the virtual character to perform the interaction operation on the interaction object corresponding to the virtual button, the method further includes:

S1-1: Obtain a first selected operation performed on the virtual button in the ready-for-activation form.

S1-2: Determine, after obtaining the first selected operation and in a case that a first release operation performed on the virtual button in the ready-for-activation form is obtained, that the target trigger condition corresponding to the interaction operation performed by the virtual character on the interaction object corresponding to the virtual button is met.

In some aspects, the target trigger condition may include, but is not limited to, a limiting condition for the first selected operation on the virtual button. Assuming that the first selected operation is a click/tap operation, the target trigger condition may include, but is not limited to, a first release operation on the virtual button, a number of times of execution of the click/tap operation on the virtual button, a tap force of the click/tap operation, a duration of the click/tap operation, and the like.

Further, for example, as shown in FIG. 5(c), the selected operation performed on the virtual button 508 in the ready-for-activation form is obtained, and then, in a case that a release operation performed on the virtual button 508 in the ready-for-activation form is obtained, the virtual button 508 in the activated form is displayed.

In some aspects, after the obtaining the first selected operation performed on the virtual button in the ready-for-activation form, the method further includes:

S2-1: Generate and display an optional interaction operation sub-interface in a case that a quantity of optional interaction operations performed by the virtual character on the interaction object corresponding to the virtual button is greater than or equal to 2, operation identifiers corresponding to the optional interaction operations performed by the virtual character on the interaction object corresponding to the virtual button being displayed on the optional interaction operation sub-interface.

S2-2: Obtain a second selected operation performed on a target operation identifier displayed on the optional interaction operation sub-interface, the target operation identifier being an operation identifier corresponding to a target optional interaction operation performed by the virtual character on the interaction object corresponding to the virtual button.

S2-3: Determine, in a case that a second release operation performed on the target operation identifier is obtained, that the target trigger condition corresponding to the interaction operation performed by the virtual character on the interaction object corresponding to the virtual button is met.

In some aspects, the optional interaction operation may be, but is not limited to, an interaction operation that may be triggered by a virtual button and that is performed by a virtual character on an interaction object corresponding to the virtual button. For example, the virtual button may trigger an interaction operation A, an interaction operation B, and an interaction operation C that are performed by the virtual character on the interaction object corresponding to the virtual button, so that after the first selected operation performed on the virtual button in the ready-for-activation form is obtained, an optional interaction operation sub-interface is displayed, and operation identifiers of the interaction operation A, the interaction operation B, and the interaction operation C are displayed on the optional interaction operation sub-interface.

In some aspects, the target trigger condition may include, but is not limited to, a limiting condition for a second selected operation on the target operation identifier. Assuming that the second selected operation is a click/tap operation, the target trigger condition may include, but is not limited to, a second release operation on the target operation identifier, a number of times of execution of the click/tap operation on the target operation identifier, a tap force of the click operation, a duration of the click/tap operation, and the like.

In some aspects, the switching the virtual button to the activated form, and controlling the virtual character to perform the interaction operation on the interaction object corresponding to the virtual button includes: switching the virtual button from the ready-for-activation form to the activated form, and performing, by the virtual character, the target optional interaction operation on the interaction object corresponding to the virtual button.

In some aspects, to further improve the convenience of the selected operation, the first selected operation may be, but is not limited to, a press-and-hold operation, and in a process of executing the press-and-hold operation, the optional interaction operation sub-interface is generated and displayed, so that the user may change an operation position of the press-and-hold operation, that is, obtain the operation position of the press-and-hold operation and adjust the operation position from the target virtual button to the target operation identifier displayed on the optional interaction operation sub-interface, to determine that the second selected operation is obtained.

Further, for example, continuously referring to FIG. 9 based on the scenario shown in FIG. 3, a press-and-hold operation (a first selected operation) performed on the virtual button C is obtained, and an optional interaction operation sub-interface 902 is generated and displayed. A plurality of operation identifiers such as an operation identifier C1, an operation identifier C2, and an operation identifier C3 are displayed on the optional interaction operation sub-interface 902. Further, after obtaining that the operation position of the press-and-hold operation is adjusted from the virtual button C to the operation identifier C3 displayed on the optional interaction operation sub-interface 902, and it is further determined that the second selected operation performed on the operation identifier C3 is obtained.

In some aspects, to further improve the convenience of the selected operation, the first selected operation may be, but is not limited to, a press-and-hold operation, and in a process of executing the press-and-hold operation, the optional interaction operation sub-interface is displayed, so that the user may change an operation direction of the press-and-hold operation, to correspond to an operation identifier displayed on the optional interaction operation sub-interface, for example, obtain a slide operation in the process of executing the press-and-hold operation, and determine a slide direction of the slide operation. Assuming that the operation identifiers displayed on the optional interaction operation sub-interface have been associated with different slide directions in advance, for example, the operation identifier A is associated with an upward direction, and the operation identifier B is associated with a downward direction, the operation identifier A is further determined as the target operation identifier in a case that the slide direction is upward.

Considering that a quantity of interaction operations that can be triggered by a virtual button and that are performed by a virtual character on an interaction object corresponding to the virtual button may be not unique, if the solution of one selected operation is used, the user may not select which interaction operation to perform. Further, this aspect provides optional options of a plurality of selected operations, to help the user to select which interaction operation to perform.

According to this aspect provided in this disclosure, after the first selected operation performed on the virtual button in the ready-for-activation form is obtained, an optional interaction operation sub-interface is generated and displayed in a case that a quantity of optional interaction operations performed by the virtual character on the interaction object corresponding to the virtual button is greater than or equal to 2, operation identifiers corresponding to the optional interaction operations performed by the virtual character on the interaction object corresponding to the virtual button being displayed on the optional interaction operation sub-interface. A second selected operation performed on a target operation identifier displayed on the optional interaction operation sub-interface is obtained, the target operation identifier being an operation identifier corresponding to a target optional interaction operation performed by the virtual character on the interaction object corresponding to the virtual button. In a case that a second release operation performed on the target operation identifier is obtained, that the target trigger condition corresponding to the interaction operation performed by the virtual character on the interaction object corresponding to the virtual button is met is determined. By switching to the activated form and controlling the virtual character to perform a target optional interaction operation on the interaction object corresponding to the virtual button, the purpose of selecting which interaction operation to be performed is achieved, and the technical effect of improving the accuracy of triggering interaction operations by using virtual buttons is achieved.

In some aspects, after the switching the virtual button to the activated form, and controlling the virtual character to perform the interaction operation on the interaction object corresponding to the virtual button, the method further includes:
eliminating the virtual button and the interaction object corresponding to the virtual button that are displayed in the virtual scene.

To improve the intuitiveness of UI (design) displaying, after switching to the activated form and controlling a virtual character to perform an interaction operation on an interaction object corresponding to the virtual button, redundant UI elements (the virtual button and the interaction object corresponding to the virtual button) on the interface are removed, and a virtual button on which an interaction operation has not been triggered and an interaction object on which an interaction operation has not been performed are reserved.

According to this aspect provided in this disclosure, by eliminating the virtual button and the interaction object corresponding to the virtual button displayed in the virtual scene, the purpose of removing redundant UI elements on the interface can be achieved, thereby implementing the technical effect of improving the intuitiveness of UI.

In some aspects, before the eliminating the virtual button and the interaction object corresponding to the virtual button that are displayed in the virtual scene, the method further includes at least one of the following:
displaying a first special effect on the virtual button in the activated form, the first special effect being configured for feeding back the interaction operation performed by the virtual character on the interaction object corresponding to the virtual button; and
or, displaying a second special effect on the interaction object corresponding to the virtual button, the second special effect being configured for prompting a release state (which may be represented by a release progress table) of the interaction object corresponding to the virtual button.

In some aspects, after a virtual button is activated to instruct a virtual character to perform an interaction operation with an interaction object corresponding to the virtual button, to improve the intuitiveness of operation experience brought by performing the interaction operation, a first special effect is displayed on the virtual button in the activated form, and a second special effect is displayed on the interaction object corresponding to the virtual button. A display duration of the first special effect/the second special effect may be, but is not limited to, in a positive correlation with a display duration of the interaction operation performed by the virtual character and the interaction object corresponding to the virtual button.

To help the user clarify related information of the interaction operation, the interaction operation performed by the virtual character on the interaction object corresponding to the virtual button is fed back in a first special effect mode. In addition, to enable the user to clarify a related presentation after the interaction operation is performed on the interaction object corresponding to the virtual button, the release state of the interaction object corresponding to the virtual button is prompted to the user in a second special effect mode, thereby improving the user experience.

According to this aspect provided in this disclosure, a first special effect is displayed on the virtual button in the activated form, the first special effect being configured for feeding back the interaction operation performed by the virtual character on the interaction object corresponding to the virtual button. A second special effect is displayed on the interaction object corresponding to the virtual button, the second special effect being configured for prompting a release state of the interaction object corresponding to the virtual button, so as to clarify related information of the interaction operation and clarify related performance after the interaction operation is performed on the interaction object corresponding to the virtual button, thereby achieving the technical effect of improving the user experience.

In some aspects, the displaying at least two virtual buttons includes: displaying the at least two virtual buttons in a preset area, positions of virtual buttons among the at least two virtual buttons in the preset area being positions obtained by performing central arrangement according to a center of the preset area.

In some aspects, the center of the preset area may be, but is not limited to, a center point of the preset area, or a center line of the preset area. The center line of the preset area may further include a center line of the preset area in the vertical direction, or a center line of the preset area in the horizontal direction, or a center line of the preset area in another direction.

After the eliminating the virtual button and the interaction object corresponding to the virtual button that are displayed in the virtual scene, the method further includes:

S3-1: Perform central arrangement on a virtual button that is still displayed among the at least two virtual buttons according to the center of the preset area, to obtain new position information.

S3-2: Display, in the preset area according to the new position information, the virtual button that is still displayed.

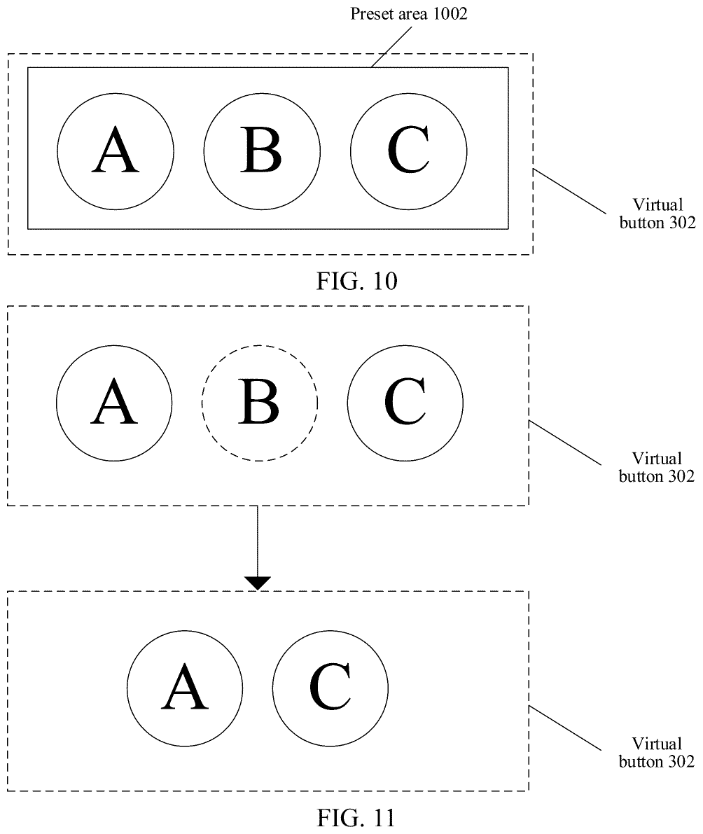

In some aspects, based on the scenario shown in FIG. 3, still as shown in FIG. 10, a plurality of virtual buttons 302 are placed in a preset area 1002. The virtual buttons among the plurality of virtual buttons 302 are arranged according to a center of the preset area 1002. The center of the preset area 1002 may be, but is not limited to, a center point of the preset area 1002, or a center line of the preset area 1002. The center line of the preset area 1002 may further include a center line of the preset area 1002 in a vertical direction, a center line of the preset area 1002 in a horizontal direction, or a center line of the preset area 1002 in another direction.

After a virtual button displayed in a virtual scene is eliminated, display of the virtual button is vacant, and arrangement appropriateness is lacked. Further, the user may habitually tap on the vacant position to trigger an original interaction operation, causing the problem of misoperations. To avoid the problem that the user does not adapt to an existing virtual button position because the displayed virtual button is eliminated, in this aspect, after the displayed virtual button and the interaction object corresponding to the virtual button are eliminated, virtual buttons that are still displayed among the at least two virtual buttons are centrally arranged according to the center of the preset area, to obtain new position information, and further the virtual buttons that are still displayed are displayed in the preset area according to the new position information.

Further, for example, continuously referring to FIG. 11 based on the scenario shown in FIG. 3, after displaying of the virtual button B among the plurality of virtual buttons 302 is canceled, positions of the virtual button A and the virtual button C are sorted again, so as to make up for a display vacancy of the virtual button B.

In this aspect provided in this disclosure, the at least two virtual buttons are displayed in a preset area, positions of virtual buttons among the at least two virtual buttons in the preset area being positions obtained by performing central arrangement according to a center of the preset area. Central arrangement is performed on a virtual button that is still displayed among the at least two virtual buttons according to the center of the preset area, to obtain new position information. The virtual buttons that are still displayed are displayed in the preset area according to the new position information, so as to avoid the problem that the user does not adapt to existing positions of the virtual buttons due to elimination of virtual buttons displayed in the virtual scene, thereby achieving the technical effect of improving allocation and appropriateness of the positions of the virtual buttons.

In this aspect provided in this disclosure, the at least two virtual buttons are displayed in a preset area, positions of virtual buttons among the at least two virtual buttons in the preset area being positions obtained by performing central arrangement according to a center of the preset area, thereby achieving the technical effect of improving the arrangement appropriateness of the positions of the virtual buttons.

In some aspects, before the switching the virtual button to the ready-for-activation form, the method further includes at least one of the following:
determining that the initial trigger condition is met in a case that a distance between the virtual character and the interaction object corresponding to the virtual button is less than or equal to a first preset threshold;
or determining that the initial trigger condition is met in a case that a quantity of obstacles between the virtual character and the interaction object corresponding to the virtual button is less than 1, or an obstacle between the virtual character and the interaction object corresponding to the virtual button does not meet a blocking condition;
or determining that the initial trigger condition is met in a case that the virtual character holds an interaction trigger prop associated with the interaction object corresponding to the virtual button;
or determining that the initial trigger condition is met in a case that the virtual character is in an interaction trigger state associated with the interaction object corresponding to the virtual button; and
or determining that the initial trigger condition is met in a case that a target attribute value of the virtual character is greater than or equal to a second preset threshold associated with the interaction object corresponding to the virtual button.

In some aspects, as shown in FIG. 5(a), an obstacle exists between the interaction object 506 and the virtual character 504, and further, the virtual button C corresponding to the interaction object 506 is still in a form of waiting to be activated.

In some aspects, in an execution process of some virtual tasks, an interaction operation performed on an interaction object may be triggered in modes including, but being not limited to, an interaction trigger prop, an interaction trigger state, and a target attribute value, so as to complete the virtual task.

In some aspects, before the displaying at least two virtual buttons, the method further includes: displaying at least one general button, the general button being configured for triggering at least two types of operations, and the at least two types of operations including an interaction operation performed by the virtual character on the interaction object in the virtual scene.

The displaying at least two virtual buttons includes: displaying, in response to a virtual button starting request, at least two virtual buttons in a virtual scene, and prohibiting a general button from triggering an interaction operation performed by the virtual character on the interaction object in the virtual scene.

After the displaying at least two virtual buttons, the method further includes: eliminating, in response to a virtual button closing request, the at least two virtual buttons displayed in the virtual scene, and allowing the general button to trigger the interaction operation performed by the virtual character on the interaction object in the virtual scene.

Considering that operation levels or habits of users are different. For example, a user having a relatively high operation skill is accustomed to using virtual buttons, to improve the execution accuracy of interaction operations. However, for some users having low operation skills and accustomed to using general buttons, the use of the virtual buttons reduces the operation efficiency of such the users. Further, the use of the virtual buttons is selectively provided for the users in a prohibit/allow mode, to improve the triggering flexibility of the virtual buttons.

In this aspect provided by this disclosure, in response to a virtual button starting request, at least two virtual buttons are displayed in a virtual scene, and a general button is prohibited from triggering an interaction operation performed by the virtual character on the interaction object in the virtual scene; and in response to a virtual button closing request, the at least two virtual buttons displayed in the virtual scene are eliminated, and the general button is allowed to trigger the interaction operation performed by the virtual character on the interaction object in the virtual scene, so that use of the virtual buttons can be selectively provided for users in a prohibit/allow mode, thereby improving the flexibility of triggering the virtual buttons.

In some aspects, for ease of understanding, the foregoing method for controlling virtual buttons is applied to a virtual game scene. In this aspect, regular interaction buttons (virtual buttons) are used to rapidly interact (an interaction operation) with a plurality of articles (interaction objects) in the scenario. Interaction articles in the scenario are arranged and displayed in an operation hot area, so that a player of the virtual game can rapidly interact with the articles.

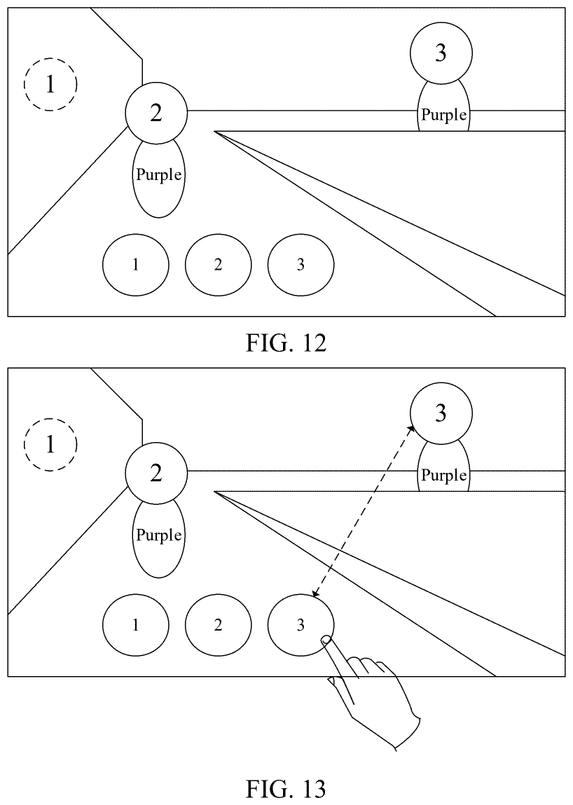

In some aspects, when there are only a plurality of interaction articles of one type, as shown in FIG. 12, the purple ellipse is an interaction article. When the interaction article is located behind a wall, interaction cannot be performed, and only a UI (interaction article 1) is displayed. The interaction articles in the scenario are annotated by using the UI according to a sequential order of placing the interaction articles. The interaction buttons can alternatively be arranged on the bottom of the screen from left to right according to the sequential order of placing the interaction articles, for example, an interaction button 1, an interaction button 2, and an interaction button 3. The interaction articles are in one-to-one correspondence with the interaction buttons. When an interaction article meets an interaction condition, a corresponding (interaction) button is lighted up. When an interaction article is located behind a wall and does not meet an interaction condition, a corresponding (interaction) button is set gray. When a player taps on the (interaction) button, a corresponding interaction article is lighted up, helping the player to determine whether the interaction article is correct. As shown in FIG. 13, when a button 3 is tapped on, a purple interaction article 3 is lighted up. After being triggered, a dynamic effect is used in the interaction button for representing a release state of the object. When the interaction article leaves a field of view range, the player can still obtain a state of the interaction article. For example, the button 3 shown in FIG. 13 may be, but is not limited to, that after being triggered, the button 3 is lighted up.

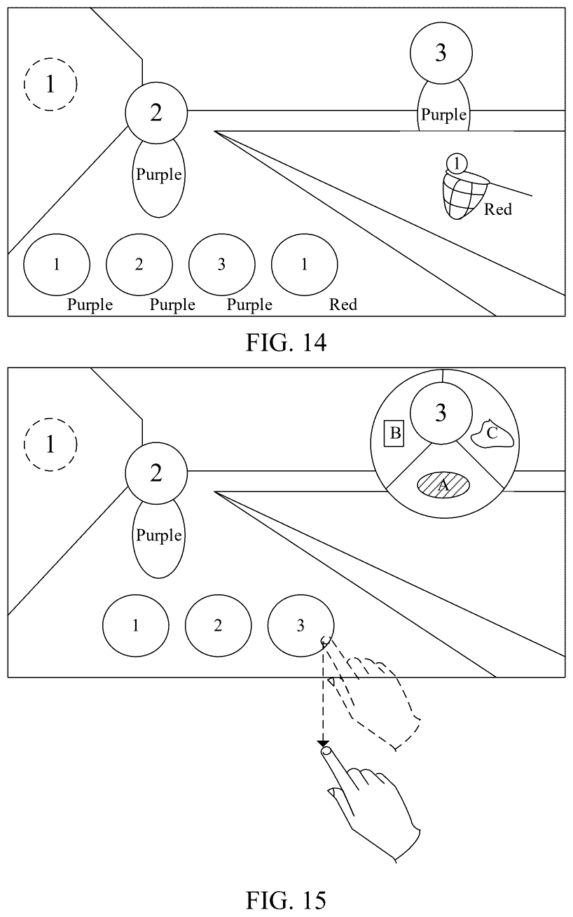

In some aspects, when there are a plurality of interaction articles of a plurality of types, based on numerals, article types are additionally distinguished by using colors. As shown in FIG. 14, two interaction articles are both marked with a numeral 1, but are distinguished by using purple and red. In addition, interaction buttons of interaction articles in a same type are placed together, and are arranged left and right according to a placement sequence. This helps the player quickly locate the interaction article that the player wants to trigger.

In some aspects, when an interaction article has a plurality of interaction modes, a slide selection trigger mode is added to an interaction button, and corresponding selection content is displayed on a screen in a form of a wheel. Based on the scenario shown in FIG. 13, still as shown in FIG. 15, a wheel is triggered for display by using a button 3, and an optional interaction operation option associated with the interaction article 3 is displayed on the wheel, so that a player can quickly select a trigger mode of an interaction article when there are a plurality of articles in the scene, and the article has a plurality of interaction modes. For example, a slide operation in a downward direction is performed on the button 3, to further trigger a selected operation for the optional interaction operation option A matched in the downward direction.

The interaction buttons of the interaction articles in the scene are resident below the screen, a plurality of interaction buttons may be displayed simultaneously, and the interaction objects are classified by using icons and colors. The player can complete the interaction with only one operation, which is beneficial for the player to rapidly complete the interaction with an article in a battle with a tense rhythm.

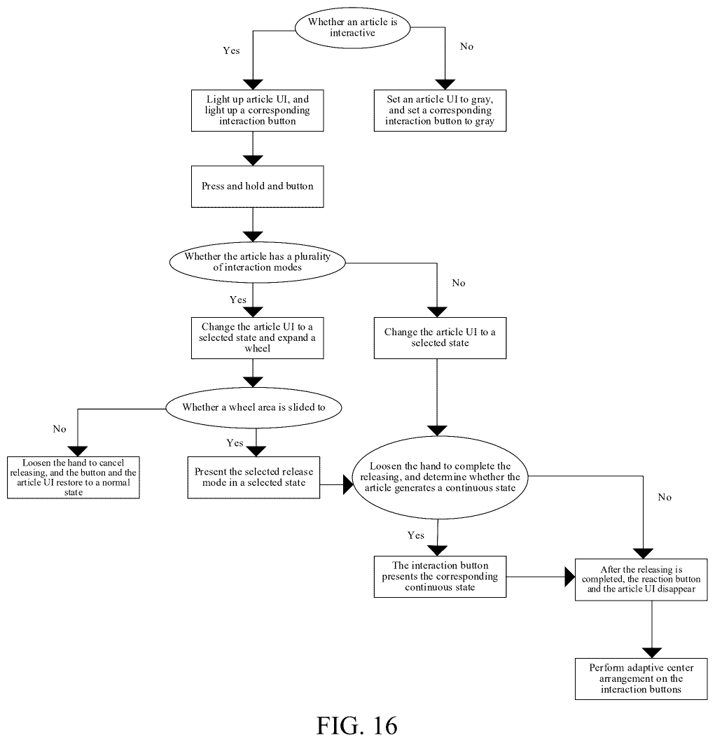

Further, for example, as shown in FIG. 16, and specific operations are as follows:

Operation 1: First determine whether there is an article meeting an interaction condition in a scene, and if yes, perform operation 2, or otherwise, perform operation 3. Determining of whether an article is interactive needs to be performed according to a limiting condition of an actual article type. First, whether an article within a field of view range is within an interaction range is determined. Second, due to the fact that some articles cannot interact if there is a partition wall, whether an article is blocked by a building needs to be determined.

Operation 2: Light up a corresponding interaction button, and perform operation 4. The corresponding interaction button is a button capable of controlling an article in the scene to be released. The player places an article in the scene, displays a corresponding UI icon and a marked numeral above the article according to a displayed article type, and generates a corresponding interaction button below the screen. Content displayed by the interaction button includes the icon of the article, an operation content description, and a marked numeral the same as that of the article. Different types of articles in a scene use scene icons of different colors, and articles of a same type are marked with numerals according to a placement sequence. Corresponding interaction buttons use a same color and a same numeral, and interaction buttons of articles of a same type are arranged together. Interaction buttons of all articles are arranged in a line and are displayed in the center of the articles on the whole.

Operation 3: Set the interaction button to gray. As shown in FIG. 15, an article 1 is placed behind a wall, and the article 1 is an article that cannot interact if there is a partition wall. Therefore, both the article UI and the interaction button are in a gray state.

Operation 4: A player presses and holds the interaction button that is lighted up, and perform operation 5.

Operation 5: Determine whether the selected article has a plurality of interaction modes. If the article has a plurality of interaction modes, perform operation 6; or otherwise, perform operation 7.

Operation 6: Present both the interaction button that is pressed and held and the article UI in the scene in a selected state, expand a wheel, and hide marked numerals. The wheel presents a plurality of interaction modes according to a quantity of article interaction modes, and operation 8 is performed.

Operation 7: When determining that the article only has one interaction mode, present both the interaction button that is pressed and held and the UI of the article in the scene in a selected state. The hand is loosened (that is, the selected interaction button is released) and operation 11 is performed.

Operation 8: Determine whether the player slides to the wheel area, and if the player does not slide to the wheel area, loosen the hand to perform operation 9; or otherwise, perform operation 10.

Operation 9: Loosen the hand to cancel the interaction with the article, and restore the article UI and the interaction button to a normal state.

Operation 10: Present selected interaction mode in a selected state, and loosen the hand to perform operation 11. The sliding direction of the interaction button relative to the wheel has a mapping relationship with a distance, that is, if the player presses the button and slides up, an interaction mode above the wheel is selected.

Operation 11: Loosen the hand to complete the interaction with the article, and determine whether the article generates continuous feedback, that is, whether the feedback is instant or continuous. If the feedback is continuous, perform operation 12; or otherwise, perform operation 13.

Operation 12: Continuous dynamic effect performance is presented on the interaction button, and a duration of the dynamic effect is consistent with a release time of the article. After the releasing of the article is completed, operation 13 is performed.

Operation 13: After the releasing of the article is completed, the article UI and the corresponding interaction button disappear, adjust spacings among the remaining interaction buttons below, the buttons on the whole being adaptively centered.

In some technical solutions, a player needs to spend a lot of time or energy. Especially, in an FPS game having character skills, a battle rhythm is relatively fast, and if a player spends an excessive time in assisting in a battle operation, the player can be easily killed by an enemy, causing a relatively strong feeling of frustration. However, according to this aspect provided in this disclosure, in a game in which a player releases a plurality of interaction articles, an operation on an article is simplified into one operation, so that the problem of complex operations during interactions of a player with articles is solved. The player can quickly release the auxiliary skill during the battle, so that the effectiveness of skill release and the feeling of smoothness of the battle can be improved.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

For ease of description, the foregoing method aspects are described as a series of action combinations. However, a person skilled in the art is to know that this disclosure is not limited to the described order of the actions because some operations may be performed in another order or performed at the same time according to this disclosure. In addition, a person skilled in the art also knows that all aspects described in the specification are some examples of aspects of this disclosure, and the related actions and modules are not necessarily required by this disclosure.

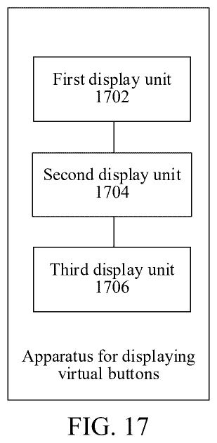

This disclosure further provides an apparatus for controlling virtual buttons for implementing the foregoing method for controlling virtual buttons. As shown in FIG. 17, the apparatus includes:
a first display unit 1702, configured to display at least two virtual buttons in a virtual scene, each of the at least two virtual buttons being displayed in a form of waiting to be activated or a ready-for-activation form, each of the at least two virtual buttons being configured for triggering a virtual character to perform an interaction operation on an interaction object corresponding to the virtual button, and interaction objects corresponding to virtual buttons among the at least two virtual buttons being different;
a second display unit 1704, configured to: for a virtual button in the form of waiting to be activated, switch the virtual button to the ready-for-activation form in a case that an initial trigger condition corresponding to the interaction operation performed by the virtual character on the interaction object corresponding to the virtual button is met; and
a third display unit 1706, configured to: for the virtual button in the ready-for-activation form, switch the virtual button to an activated form in a case that a target trigger condition corresponding to the interaction operation performed by the virtual character on the interaction object corresponding to the virtual button is met, and control the virtual character to perform the interaction operation on the interaction object corresponding to the virtual button.

For specific aspects, refer to the example shown in the foregoing method for controlling virtual buttons, which is not described again in this example.

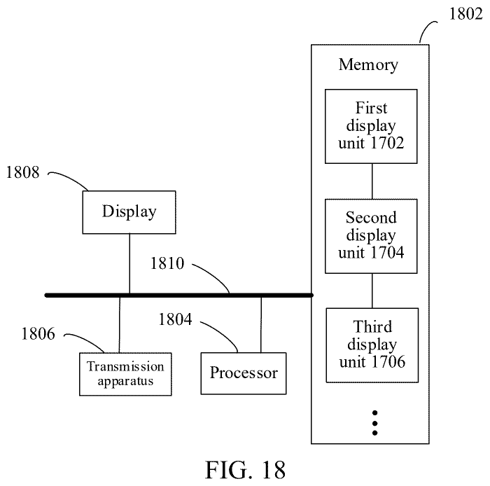

An aspect of this disclosure further provides an electronic device for implementing the method for controlling virtual buttons. The electronic device may be, but is not limited to, the user equipment 102 or the server 112 shown in FIG. 1. In this aspect, for example, the electronic device is the user equipment 102. Further, as shown in FIG. 18, the electronic device includes a memory 1802 (e.g., a non-transitory computer-readable storage medium) and a processor 1804 (e.g., processing circuitry). The memory 1802 stores a computer program. The processor 1804 is configured to perform the operations in any one of the foregoing method aspects through the computer program.

In some aspects, the foregoing electronic device may be located in at least one of a plurality of network devices in a computer network.

In some aspects, the foregoing processor may be configured to use the computer program to perform the following operations:

S1: Display at least two virtual buttons in a virtual scene, each of the at least two virtual buttons being displayed in a form of waiting to be activated or a ready-for-activation form, each of the at least two virtual buttons being configured for triggering a virtual character to perform an interaction operation on an interaction object corresponding to the virtual button, and interaction objects corresponding to virtual buttons among the at least two virtual buttons being different.

S2: For a virtual button in the form of waiting to be activated, switch the virtual button to the ready-for-activation form in a case that an initial trigger condition corresponding to the interaction operation performed by the virtual character on the interaction object corresponding to the virtual button is met.

S3: For the virtual button in the ready-for-activation form, switch the virtual button to the activated form in a case that a target trigger condition corresponding to the interaction operation performed by the virtual character on the interaction object corresponding to the virtual button is met, and control the virtual character to perform the interaction operation on the interaction object corresponding to the virtual button.

A person of ordinary skill in the art may understand that the structure shown in FIG. 18 is only schematic, and does not limit the structure of the foregoing electronic device. For example, the electronic device may further include more or fewer components (for example, a network interface) than those shown in FIG. 18, or has a configuration different from that shown in FIG. 18.

The memory 1802 may be configured to store a software program and a module, for example, program instructions/modules corresponding to the method and apparatus for controlling virtual buttons in the aspects of this disclosure. The processor 1804 runs the software program and the module stored in the memory 1802, to implement various functional applications and data processing, that is, implement the foregoing method for controlling virtual buttons. The memory 1802 may include a high-speed random memory, and may also include a non-volatile memory, for example, one or more magnetic storage apparatuses, a flash memory, or another nonvolatile solid-state memory. In some aspects, the memory 1802 may further include memories remotely disposed relative to the processor 1804, and these remote memories may be connected to the electronic device through a network. Examples of the network include, but are not limited to, the Internet, an intranet, a local area network, a mobile communication network, and a combination thereof. The memory 1802 may be specifically, but is not limited to, configured to store information such as, a virtual button, an interaction object, and an interaction operation. For an example, as shown in FIG. 18, the memory 1802 may include, but is not limited to, the first display unit 1702, the second display unit 1704, and the third display unit 1706 in the foregoing apparatus for controlling virtual buttons. In addition, the memory 1802 may further include, but is not limited to, another module unit in the foregoing apparatus for controlling virtual buttons. This is not described again in this example.

In some aspects, the foregoing transmission apparatus 1806 is configured to receive or transmit data through a network. Specific instances of the foregoing network may include a wired network and a wireless network. In an example, the transmission apparatus 1806 includes a network interface controller (NIC). The NIC may be connected to another network device and a router by using a network cable, so as to communicate with the Internet or a local area network. In an example, the transmission apparatus 1806 is a radio frequency (RF) module, which communicates with the Internet in a wireless manner.

In addition, the foregoing electronic device further includes: a display 1808, configured to display information such as the foregoing virtual button, interaction object, and interaction operation; and a connection bus 1810, configured to connect various module components in the foregoing electronic device.

In some other aspects, the foregoing user equipment or server may be a node in a distributed system. The distributed system may be a blockchain system, the blockchain system may be a distributed system formed by connecting a plurality of nodes through network communication. A peer-to-peer (P2P for short) network may be formed between the nodes, and any form of computing device, for example, electronic devices, such as a server or user equipment, may be used as a node in the blockchain system by adding the peer-to-peer network.

According to an aspect of this disclosure, a computer program product is provided. The computer program product includes a computer program/instructions, and the computer program/instructions includes program code configured for performing the method shown in the flowchart. In such an aspect, the computer program may be downloaded and installed from the network through a communication part, and/or may be installed from a removable medium. When the computer program is executed by a central processing unit, the computer program executes functions provided in the aspects of this disclosure.

The sequence numbers of the foregoing aspects of this disclosure are merely for description purpose but do not imply the preference among the aspects.

The computer system of the electronic device shown is merely an example, and does not constitute any limitation on functions and use ranges of the aspects of this disclosure.

The computer system includes a central processing unit (CPU), which can perform various suitable actions and processing according to a program stored in a read-only memory (ROM) or a program loaded from a storage part into a random access memory (RAM). The random access memory further stores various programs and data required for system operations. The central processing unit, the read-only memory, and the random access memory are connected to each other through a bus. An input/output interface (that is, an I/O interface) is also connected to the bus.

The following components are connected to the input/output interface: an input part including a keyboard, a mouse, or the like; an output part including a cathode ray tube (CRT), a liquid crystal display (LCD), a speaker, or the like; the storage part including a hard disk, or the like; and a communication part including a network interface card such as a local area network card, a modem, or the like. The communication part performs communication processing by using a network such as the Internet. A driver is also connected to the input/output interface as needed. A removable medium, such as a magnetic disk, an optical disc, a magneto-optical disk, or a semiconductor memory, is installed on the driver as required, so that a computer program read from the removable medium is installed into the storage part as required.

Particularly, according to the aspects of this disclosure, the processes described in the various method flowcharts may be implemented as computer software programs. For example, this aspect of this disclosure includes a computer program product, the computer program product includes a computer program carried on a computer-readable medium, and the computer program includes program code configured for performing the methods shown in the flowcharts. In such an aspect, the computer program may be downloaded and installed from the network through a communication part, and/or may be installed from a removable medium. When the computer program is executed by the central processing unit, the various functions defined in the system of this disclosure are executed.

An aspect of this disclosure further provides a computer-readable storage medium such as a non-transitory computer-readable storage medium. A processor of a computer device reads computer instructions from the computer-readable storage medium. The processor executes the computer instructions, to enable the computer device to perform the method provided in the foregoing various implementations.

In some aspects, the computer-readable storage medium may be configured to store a computer program configured for performing the following operations:

S1: Display at least two virtual buttons in a virtual scene, each of the at least two virtual buttons being displayed in a form of waiting to be activated or a ready-for-activation form, each of the at least two virtual buttons being configured for triggering a virtual character to perform an interaction operation on an interaction object corresponding to the virtual button, and interaction objects corresponding to virtual buttons among the at least two virtual buttons being different.

S2: For a virtual button in the form of waiting to be activated, switch the virtual button to the ready-for-activation form in a case that an initial trigger condition corresponding to the interaction operation performed by the virtual character on the interaction object corresponding to the virtual button is met.

S3: For the virtual button in the ready-for-activation form, in a case that a target trigger condition corresponding to the interaction operation performed by the virtual character on the interaction object corresponding to the virtual button is met, switch the virtual button to the activated form, and control the virtual character to perform the interaction operation on the interaction object corresponding to the virtual button.

In some aspects, a person of ordinary skill in the art may understand that all or some operations in the methods of the foregoing aspects may be performed by a program instructing relevant hardware of the electronic device. The program may be stored in a computer-readable storage medium such as a non-transitory computer-readable storage medium. The storage medium may include: a flash drive, a Read-Only Memory (ROM), a Random Access Memory (RAM), a magnetic disk, an optical disc, and the like.

The sequence numbers of the foregoing aspects of this disclosure are merely for description purpose but do not imply the preference among the aspects.

When the integrated unit in the foregoing aspects is implemented in a form of a software functional unit and sold or used as an independent product, the integrated unit may be stored in the foregoing computer-readable storage medium. Based on such an understanding, the technical solutions of this disclosure essentially, or a part contributing to the related art, or all or a part of the technical solution may be implemented in a form of a software product. The computer software product is stored in a storage medium and includes several instructions for instructing one or more computer devices (which may be a PC, a server, a network device or the like) to perform all or some of steps of the methods in the aspects of this disclosure.

In the foregoing aspects of this disclosure, the descriptions of the aspects have respective focuses. For a part that is not described in detail in an aspect, refer to related descriptions in other aspects.

In the several aspects provided in this disclosure, the disclosed user equipment may be implemented in another manner. The apparatus aspects described above are merely some examples of aspects of this disclosure. For example, the division of the units is merely the division of logic functions, and may use other division manners during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection by means of some interfaces, units, or modules, and may be electrical or of other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of this aspect.

In addition, functional units in the aspects of this disclosure may be integrated into one processing unit, or each of the units may be physically separated, or two or more units may be integrated into one unit. The integrated unit may be implemented in the form of hardware, or may be implemented in a form of a software functional unit.

The foregoing descriptions are merely some examples of aspects of this disclosure. A person of ordinary skill in the art may further make several improvements and modifications without departing from the principle of this disclosure, and the improvements and modifications fall within the scope of this disclosure.

What is claimed is:

1. A method for displaying virtual buttons, the method comprising:
displaying a plurality of virtual buttons in a virtual scene, each virtual button of the plurality of virtual buttons being displayed in one of an inactive form, a selectable form, and an activated form, each virtual button being configured to trigger a virtual character to perform an interaction operation on an interaction object of the respective virtual button, the interaction objects of the plurality of virtual buttons being different;
in response to a determination that an initial condition associated with a virtual button of the plurality of virtual buttons being satisfied, switching the virtual button from the inactive form to the selectable form;
in response to a determination that the virtual button is triggered, switching the virtual button from the selectable form to the activated form; and
in response to the virtual button being in the activated form, controlling the virtual character to perform the interaction operation on the interaction object corresponding to the virtual button.

2. The method according to claim 1, wherein the displaying the plurality of virtual buttons comprises:
displaying a first virtual button of the plurality of virtual buttons with a first mark and a second virtual button of the plurality of virtual buttons with a second mark, the first virtual button being different from the second virtual button, the first mark indicating a first interaction object corresponding to the first virtual button, and the second mark indicating a second interaction object corresponding to the second virtual button.

3. The method according to claim 2, wherein the displaying the first virtual button and the second virtual button comprises:
determining a first display order of the first mark and a second display order of the second mark based on a sorting rule, the sorting rule corresponding to mark types of the first mark and the second mark; and
displaying the first virtual button before the second virtual button in response to the first display order being before the second display order.

4. The method according to claim 2, wherein the displaying the first virtual button and the second virtual button comprises:
when the first interaction object and the second interaction object are of a same object type, displaying the first virtual button with a first display attribute and displaying the second virtual button with the first display attribute, the first display attribute indicating the object type; and
when the first interaction object and the second interaction object are different object types, displaying the first virtual button with a second display attribute and displaying the second virtual button with a third display attribute, the second display attribute indicating an object type of the first interaction object, the third display attribute indicating an object type of the second interaction object.

5. The method according to claim 4, further comprising:
when the first interaction object and the second interaction object are of a same object type, displaying the first virtual button and the second virtual button in a same area; and
when the first interaction object and the second interaction object are of different object types, displaying the first virtual button in a first display area and displaying the second virtual button in a second display area that is different from the first display area.

6. The method according to claim 1, wherein the determination that the virtual button is triggered comprises:
obtaining a first selected operation performed on the virtual button in the selectable form;
obtaining a first release operation performed on the virtual button; and
determining that the virtual button is triggered in response to the obtained first release operation.

7. The method according to claim 6, wherein
when the virtual button is associated with a plurality of interaction operations performable by the virtual character on the interaction object of the virtual button, the method further comprises:
generating an interaction operation sub-interface;
displaying operation identifiers on the interaction operation sub-interface, each of the operation identifiers corresponding to a respective interaction operation of the plurality of interaction operations associated with the virtual button;
obtaining a second selection operation performed on a target operation identifier of the operation identifiers, the target operation identifier corresponding to one of the plurality of interaction operations associated with the virtual button;
obtaining a second release operation performed on the target operation identifier;
determining that the virtual button is triggered based on the obtained second release operation; and
the controlling the virtual character to perform the interaction operation includes controlling the virtual character to perform the one of the plurality of interaction operations on the interaction object of the virtual button.

8. The method according to claim 1, further comprising:
removing the virtual button and the interaction object of the virtual button from display in the virtual scene based on the virtual character being controlled to perform the interaction operation.

9. The method according to claim 8, further comprising at least one of:
displaying a first special effect on the virtual button in the activated form, the first special effect providing feedback of the interaction operation; or
displaying a second special effect on the interaction object of the virtual button, the second special effect indicating a release state of the interaction object of the virtual button.

10. The method according to claim 8, wherein the displaying the plurality of virtual buttons comprises:
displaying the plurality of virtual buttons in a preset area.

11. The method according to claim 10, further comprising: based on the virtual button and the interaction object of the virtual button being removed, the method further comprises:
rearranging remaining virtual buttons of the plurality of virtual buttons in the preset area to obtain updated position information; and
displaying the remaining virtual buttons in the preset area according to the updated position information.

12. The method according to claim 1, wherein the determination that the initial condition is satisfied comprises at least one of:
determining that the initial condition is satisfied when a distance between the virtual character and the interaction object of the virtual button is less than or equal to a first preset threshold;
determining that the initial condition is satisfied when a quantity of obstacles between the virtual character and the interaction object of the virtual button is less than one, or an obstacle between the virtual character and the interaction object of the virtual button does not meet a blocking condition;
determining that the initial condition is satisfied when the virtual character holds an interaction trigger prop associated with the interaction object of the virtual button;
determining that the initial condition is satisfied when the virtual character is in an interaction trigger state associated with the interaction object of the virtual button; or
determining that the initial condition is satisfied when a target attribute value of the virtual character is greater than or equal to a second preset threshold associated with the interaction object of the virtual button.

13. The method according to claim 1, further comprising:
displaying a general button configured to trigger at least two types of operations of the plurality of interaction operations;
wherein the displaying the plurality of virtual buttons comprises:
receiving a virtual button activation request;
in response to the virtual button activation request, displaying the plurality of virtual buttons and disabling the general button that is configured to trigger the at least two types of operations; and
after the displaying the plurality of virtual buttons:
receiving a virtual button deactivation request; and
in response to the virtual button deactivation request, removing the plurality of virtual buttons from display and enabling the general button to trigger the interaction operation performed by the virtual character on the interaction object.

14. An apparatus for displaying virtual buttons, comprising:
processing circuitry configured to:
display a plurality of virtual buttons in a virtual scene, each virtual button of the plurality of virtual buttons being displayed in one of an inactive form, a selectable form, and an activated form, each virtual button being configured to trigger a virtual character to perform an interaction operation on an interaction object of the respective virtual button, the interaction objects of the plurality of virtual buttons being different;
in response to a determination that an initial condition associated with a virtual button of the plurality of virtual buttons being satisfied, switch the virtual button from the inactive form to the selectable form;
in response to a determination that the virtual button is triggered, switch the virtual button from the selectable form to the activated form; and
in response to the virtual button being in the activated form, control the virtual character to perform the interaction operation on the interaction object corresponding to the virtual button.

15. The apparatus according to claim 14, wherein the processing circuitry is configured to:
display a first virtual button of the plurality of virtual buttons with a first mark and a second virtual button of the plurality of virtual buttons with a second mark, the first virtual button being different from the second virtual button, the first mark indicating a first interaction object corresponding to the first virtual button, and the second mark indicating a second interaction object corresponding to the second virtual button.

16. The apparatus according to claim 15, wherein the processing circuitry is configured to:
determine a first display order of the first mark and a second display order of the second mark based on a sorting rule, the sorting rule corresponding to mark types of the first mark and the second mark; and
display the first virtual button before the second virtual button in response to the first display order being before the second display order.

17. The apparatus according to claim 15, wherein the processing circuitry is configured to:
when the first interaction object and the second interaction object are of a same object type, display the first virtual button with a first display attribute and display the second virtual button with the first display attribute, the first display attribute indicating the object type; and
when the first interaction object and the second interaction object are different object types, display the first virtual button with a second display attribute and display the second virtual button with a third display attribute, the second display attribute indicating an object type of the first interaction object, the third display attribute indicating an object type of the second interaction object.

18. The apparatus according to claim 17, wherein the processing circuitry is configured to:
when the first interaction object and the second interaction object are of a same object type, display the first virtual button and the second virtual button in a same area; and
when the first interaction object and the second interaction object are of different object types, display the first virtual button in a first display area and display the second virtual button in a second display area that is different from the first display area.

19. The apparatus according to claim 14, wherein the processing circuitry is configured to:
obtain a first selected operation performed on the virtual button in the selectable form;
obtain a first release operation performed on the virtual button; and
determine that the virtual button is triggered in response to the obtained first release operation.

20. A non-transitory computer-readable storage medium storing instructions which, when executed by a processor, cause the processor to perform:
displaying a plurality of virtual buttons in a virtual scene, each virtual button of the plurality of virtual buttons being displayed in one of an inactive form, a selectable form, and an activated form, each virtual button being configured to trigger a virtual character to perform an interaction operation on an interaction object of the respective virtual button, the interaction objects of the plurality of virtual buttons being different;
in response to a determination that an initial condition associated with a virtual button of the plurality of virtual buttons being satisfied, switching the virtual button from the inactive form to the selectable form;
in response to a determination that the virtual button is triggered, switching the virtual button from the selectable form to the activated form; and
in response to the virtual button being in the activated form, controlling the virtual character to perform the interaction operation on the interaction object corresponding to the virtual button.
